(19) United States
(12) Patent Application Publication
(10) Pub. No.: US 2004/0168122 A1
(43) Pub. Date: Aug. 26, 2004

(54) System, method and computer readable medium for transferring and rendering a web page

(76) Inventor: Senthil Nathan Kobipalayam Murugaiyan, Gobi (IN)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/370,951

(22) Filed: Feb. 21, 2003

(51) Int. Cl. G06F 15/00

(52) U.S. Cl. 715/513

(57) ABSTRACT

A method of rendering a web page on a computer is disclosed. In the prior art, a server serves a web page only when both static and dynamic contents of the web page are available. The dynamic contents, which are usually not readily available, require some processing time and thus a user requesting the web page usually experiences a noticeable delay. The method of the present invention includes receiving data of the page from a second computer, where the data includes a dynamic reference referencing dynamic data that at least partially defines the page. The page is then partially rendered on the first computer by first rendering available page data other than the dynamic data. The dynamic data associated with the dynamic reference is received, and the received dynamic data is rendered to complete rendering of the page on the first computer.

### BACKGROUND

This invention relates to the World Wide Web, and more particularly, to a system and a method for transferring information defining a Web page from a server computer (server hereinafter) to a client computer (client hereinafter) for rendering on the client.

The worldwide network of computers commonly known as the Internet has seen explosive growth. This growth has been fueled mainly by the introduction and widespread use of web browsers, which allow for simple graphical user interface (GUI)-based access to network servers that support documents, more commonly known as Web pages. The World Wide Web (WWW) is the collection of servers of the Internet that utilizes the Hypertext Transfer Protocol (HTTP). HTTP is a known application protocol that provides user access to files (which can be in different formats such as text, graphics, images, sound, video, etc.) using a standard page description language, such as the Hypertext Markup Language (HTML). HTML provides basic document formatting and allows specifications of “links” to other servers and files. Use of an HTML-compliant client browser involves specification of a link to a server via a Uniform Resource Locator (URL). Upon such specification, the client makes a Transmission Control Protocol/Internet Protocol (TCP/IP) request to the server and receives a Web page from the server in return.

The Web page typically contains both static and dynamic contents. Static contents do not change over time. Unlike static contents, dynamic contents change over time. A simple example of a dynamic content is a stock price. The dynamic contents are not readily available; some processing is usually necessary to obtain these dynamic contents. In the prior art, the server serves such a Web page to the client only when both the static and the dynamic contents are made available. A user at the client therefore experiences a noticeable delay of several seconds waiting for the server to process the dynamic contents.

### SUMMARY

According to an aspect of the present invention, there is provided a method of rendering a page on a first computer. The method includes receiving data of the page from a second computer, where the data includes a dynamic reference referencing dynamic data that at least partially defines the page. The page is then partially rendered on the first computer by first rendering available page data other than the dynamic data. The dynamic data associated with the dynamic reference is received, and the received dynamic data is rendered to thereby complete rendering of the page on the first computer. The dynamic data may be requested using the dynamic reference, wherein the dynamic reference may include a JavaScript.

With the present invention, a better user experience is provided since contents transferred over the network is reduced and hence a faster response time.

### BRIEF DESCRIPTION OF DRAWINGS

The invention will be better understood with reference to the drawings, in which:

FIG. 1 is a diagram of an Internet environment including at least a client and a server according to an embodiment of the present invention;

FIG. 2 is a block diagram of elements of a computing device that may be used to perform the functions of the client and the server in FIG. 1;

FIG. 3 is a diagram showing an exchange of messages and files between the server and the client in FIG. 1 for downloading a Web page; and

FIG. 4 is a diagram showing the relationship between the files in FIG. 3.

### DETAILED DESCRIPTION

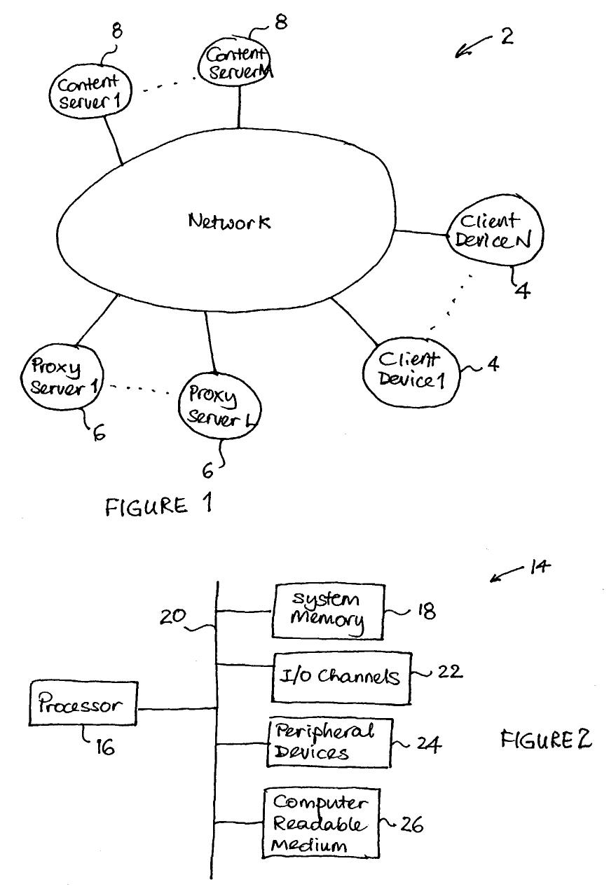

FIG. 1 shows an example of an Internet environment 2 wherein an embodiment of the present invention may be implemented. The Internet environment 2 includes client devices 4, proxy servers 6 and content servers 8. The Internet allows easy access to services such as electronic mail, internet relay chats, real time voice conversations and to a wealth of information on what has come to be known as the World Wide Web (WWW) or the Web for short. The WWW is defined by all the resources and users on the Internet that are using the Hypertext Transfer Protocol (HTTP). A client 4 depends on one of the servers 6, 8 to deliver information. Typically, the client 4 is a local personal computer (PC) while the server 6, 8 is usually a more powerful computer that houses the data.

More specifically, the client 4 is a browser application on the PC and the server 6,8 is a host computer located somewhere on the Internet. The Microsoft Internet Explorer and the Netscape Navigator are two of the more popular browsers available. When used, the browser sends a request for a specific Web page to the server 6, 8 over an established connection. The server 6, 8 processes or answers that request and sends data defining the Web page back to the browser. The connection between the client 4 and the server 6, 8 is maintained only while the exchange of information is being transacted. Thus, after the data defining a Web page is transferred from the server 6, 8, the HTTP connection between the server 6, 8 and the client 4 is terminated.

More information regarding the WWW may be found in the book, “How the World Wide Web Works,” by Chris Shipley and Matthew Fish, published by Ziff-Davis Press.

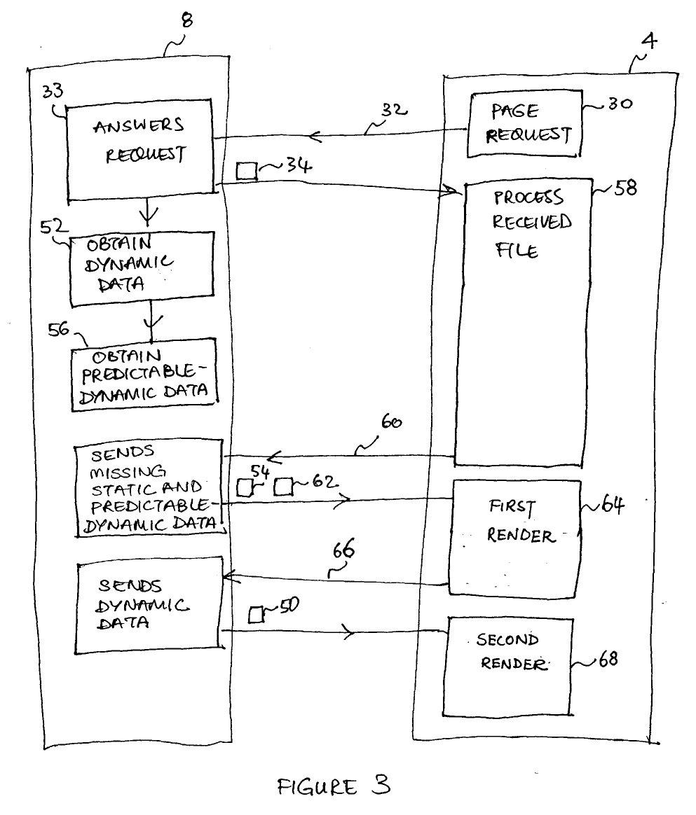

FIG. 2 is a block diagram illustrating typical elements of a computing device 14 that may be appropriately programmed to function as a client 4 or a server 6, 10 of FIG. 1. The elements include a programmable processor 16 connected to a system memory 18 via a system bus 20. The processor 16 accesses the system memory 18 as well as other input/output (I/O) channels 22 and peripheral devices 24. The computing system 14 further includes at least one computer readable medium 26, such as a CD-ROM, tape, magnetic media, EPROM, EEPROM, ROM or the like. The computing device 14 stores one or more computer programs that implement a method of transferring and rendering a Web page according to an embodiment of the present invention. The processor 16 reads and executes the one or more computer programs to perform the method. Each of the computer programs may be implemented in any desired computer programming language (including machine, assembly, high level procedural, and object oriented programming languages). In any case, the language may be a compiled or interpreted language.

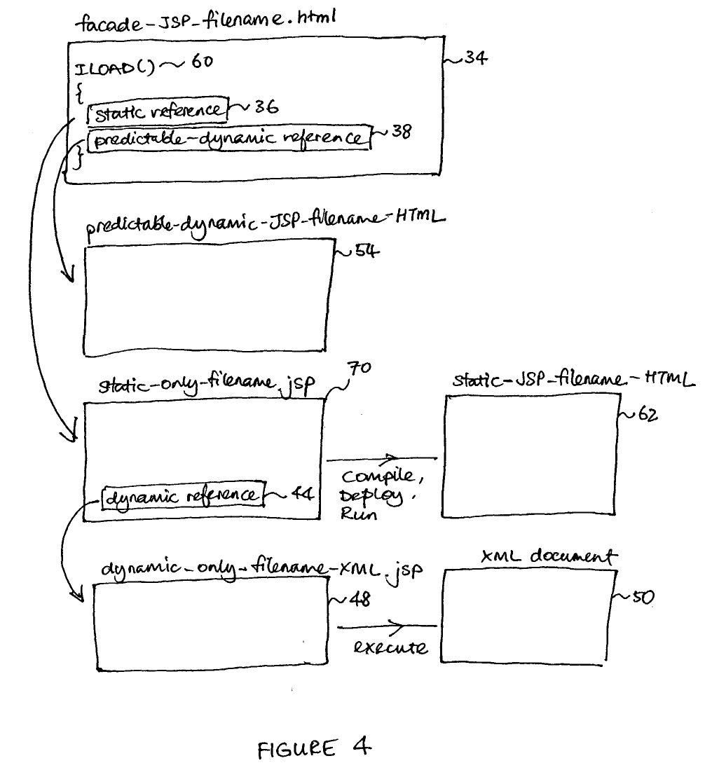

FIG. 3 is a block diagram showing a client 4 and a server 8 in an exchange of messages and files during a session. FIG. 4 shows the relationship between the files. The session starts when the client 4 receives a request for a specific Web page from a user in a PAGE REQUEST step 30. The client 4 forwards a page request message 32 to the server 8. The request message 32 includes any predictable-dynamic contents (not shown) associated with the requested page. Such predictable-dynamic contents are obtainable, for example, from cookies that the server 8 stores at the client 4.

Predictable dynamic contents are partially dynamic. For example, a set of characters representing the word “Welcome” may be different in different languages. Although it appears to be a dynamic string (dynamic contents), it is not always dynamic but depends upon an input parameter such as a language cookie or Browsers language setting. Typically, during the first request of a web page, the predictable dynamic contents are calculated and cached; thereafter the predictable dynamic contents are retrieved from the cache upon the next same request. Cached contents are referenced through an index formed from input parameters. Using the above example, dynamic contents for “Welcome” depend upon two parameters: language cookie and country cookie. Accordingly, the predictable dynamic contents for “welcome” may be cached as:

ENGLISH-WELCOME-SINGAPORE->“WELCOME TO CITY STATE” ENGLISH-WELCOME-INDIA->“WELCOME TO HINDUSTAN”.

Hence, the dynamic contents for “welcome” are built once and cached till the next request for the same web page, where the predictable dynamic contents are then served from the cache.

Upon receiving the page request from the client 4, the server 8 processes or answers the page request by downloading or sending a file 34 whose contents define the page to the client 4. The file contents are described using any language suitable for defining a page, such as Hypertext Markup Language (HTML) and other similar languages. An embodiment of the present invention will be described by way of a requested page defined by an HTML file “facade-JSP-filename.html” 34.

The following sets out an example of “facade-JSP-filename.html”:

```
    <!—Example HTML file with Java script →
    <!—FileName - facade-JSP-Stock Quote.html→
    <SCRIPT Language=‘JavaScript’>
    function ILOAD( ){
  content = if exists in cache “welcome-predictable-dynamic” load
  FromDiskCache(“welcome-predictable-dynamic”) else
  getFromServer(“welcome-predictable-dynamic”)
  content = content + if exists in cache “stock-quote-header” load
  FromDiskCache(“stock-quote-header”) else getFromServer(“stock-
  quote-header”)
  content = content + if exists in cache “stock-quote-static-content”
  loadFromDiskCache(“StockQuoteStaticContent”) else
  getFromServer(“StockQuoteContent”)
  content = content + if exists in cache “stock-quote-footer”
  loadFromDiskCache(“StockQuoteFooter“) else
  getFromServer(“StockQuoteFooter”)
  document.write(content)
}
function onInit( ){
ILOAD( )
}
</SCRIPT>
```

This facade-JSP-filename.html file 34 contains a static reference 36 and a predictable-dynamic reference 38. The static reference 36 references static data of the page while the predictable-dynamic data 38 references predictable-dynamic data of the page. The static data includes a third reference—a dynamic reference 44 that references dynamic data of the page. The predictable-dynamic data may also include a dynamic reference 44. The static data, predictable-dynamic data and dynamic data are available on the server 8.

In processing the page request, the server 8 also executes a dynamic-only-filename-XML.jsp file 48, that is associated with the requested page, to produce an XML document 50 at the server 8 in an OBTAIN DYNAMIC DATA step 52. The contents of this XML document 50 define the dynamic data of the page at this instant.

The following sets out an example of a “dynamic-only-filename-XML.jsp” file:

<?xml version=“1.0” standalone=“true”?>
<%! String server = “www.stockquote.com”;
String port =“5055” %>
<stockquote:quote xmlns=http://www.stockquote.com/xml/schema/>
<%= utiil.getStockQuote(server,port)%>
</stockquote:quote>

The following sets out an example of an XML document “dynamic-data-xml”;

<?xml version=“1.0” standalone=“true”?>
<stockquote:quote xmlns=http://www.stockquote.com/xml/schema/>
19$
</stockquote:quote>

The server 8 also checks the availability of a predictable-dynamic-JSP-HTML file 54 associated with the predictable-dynamic parameters received in the page request message in an OBTAIN PREDICTABLE-DYNAMIC DATA IF NOT AVAILABLE step 56. If it is determined in this step 56 that the predictable-dynamic-JSP-HTML file 54 corresponding to the received parameters is available, the server 8 takes no further action. However, if the predictable-dynamic-JSP-HTML file 54 is not available at the server, the server 8 creates the file 54. The following is an example of a predictable-dynamic-JSP-HTML file 54:

```
<%@page import java.lang.*, java.util.*%>
<%! String language = request.getParameter(“language”);
  String country = request.getParameter(“country”);;
  String key = null;
  String value = null;
%>
<%--Predictable dynamic key - value pairs --%>
<% key = language + “_WELCOME_” + country;
  value = cache.getValue(key);
  if(value == null) {
    value = computeValueForInputs(language, country);
    cache.put(key, value);;
  }
value= key+“=”+value%>
<%=value%>
```

As the server 8 prepares the XML document 50 and the predictable-dynamic-JSP-HTML file 54, the client 4 processes the received facade-JSP-filename.html file 34 and executes an ILOAD( ) JavaScript function 60 in that file 34 in a PROCESS RECEIVED FILE step 58. In executing the ILOAD( ) function 60, the client 4 checks if the static and the predictable-dynamic data referenced in the facade-JSP-filename.html file 34 are available in a local cache of the client 4. If it is determined that any one of the referenced static data and the predictable-dynamic data is not available in the local cache, the client 4 proceeds to request the missing data from the server 8 by sending a first missing data request message 60 to the server 8.

The server 8 responds to the first missing data request by sending the requested missing data to the client 4, that is, by sending either one or both of a static-JSP-HTML file 62 and the predictable-dynamic-JSP-HTML file 54.

The following is an example of a Static-JSP-HTML file 62:

```
    HP stock quote <BR>
    This stock quote is updated every 60 seconds. <BR>
    Stock Quote Symbol: HPQ <BR>
    Stock Quote Value getDynamicData(“stockquote:quote”); <BR>
    <script language=‘JavaScript’>
function getFynamicData(Parameter){
Here goes the logic to contact the SOAP server and get
the dynamic data and find the
value corresponding to the key passed in as a function parameter.
}
  </script>
```

The contents of this static-JSP-HTML file 62 define the static data. The contents are notated using the Hypertext Markup Language (HTML). The contents include text and specifications about where images or other multimedia files are to be placed when the page is rendered or displayed.

The client 4 on receiving the file or files 54, 62 stores it/them in the local cache for subsequent use. The client 4 next partially renders the page using the static data and predictable-dynamic data defined by the contents of the two files 54, 62 in a FIRST RENDER step 64. Partial rendering of the page involves formatting and appending appropriate predictable-dynamic data to the static-JSP-HTML file 62. The resultant contents of the static-JSP-HTML file 62 are then displayed on the display screen using a document.write( ) function provided by the client 4.

Next, the client 4 executes any placeholder JavaScript function present in the static-JSP-HTML file 62 and/or the predictable-dynamic-JSP-HTML file 54. These placeholder JavaScript functions serve as the dynamic data reference 44. In executing these placeholder JavaScript functions, the client 4 sends the server 8 a second data request message 66 to request for the dynamic data that is referenced by the dynamic data reference 44. In response to this second data request, the server 8, in this particular example, sends the XML document 50, which was prepared earlier in anticipation of the second data request, to the client 4. The XML document 50 is sent using any suitable protocol, such as the Simple Object Access Protocol (SOAP) especially if the server 8 and the client 4 are running on devices with different operating systems. Placeholder functions in predictably dynamic data will perform in a similar way for obtaining the dynamic data.

Upon receiving the XML document, a suitable parser, such as a SOAP-XML parser if the SOAP protocol was used for the transfer, in the client 4 parses the XML document 50 to extract the dynamic data. The client 4 then stores the extracted dynamic data into an array. Data required during execution of any remaining JavaScript functions can then be obtained from the array. There is no need for the client 4 to further request any data from the server. When all the required dynamic data is obtained, the client renders the dynamic data in a SECOND RENDER step 68 to thereby complete the rendering of the requested page.

Advantageously, the above-described method gives the user the perception of a shorter and therefore better response time than does the prior art method because not all data of a Web page needs to be loaded from a server before rendering commences. According to the method, static data and predictable-dynamic data are rendered in a first pass without having to wait for dynamic data to be ready. The dynamic data is subsequently rendered in a second pass to complete rendering of the page.

A tool is provided at the server 6, 8 to automatically convert a prior art JSP page, which contains all data including dynamic data, to the files described above that is suitable for use with the above-described method. To obtain the files, the tool performs the following steps on a filename.jsp file.

The following is an example of a filename.jsp (“StockQuote.jsp”) file:

```
<%-- JSP file for getting the stock quote ---%>
<%-- StockQuote.jsp --%>
<% public static getStockQuote( ){
  Socket.openConnection(www.stockquote.com, xyz);
  String value = Socket.getData( )
  Out.write(value);
  %>
HP stock quote <BR>
This stock quote is updated every 60 seconds. <BR>
Stock Quote Symbol: HPQ <BR>
Stock Quote Value <%= getStockQuote( )%><BR>
```

The tool copies the contents of the “StockQuote.jsp” file to a static-only-filename.jsp file 70. The dynamic data in this static-only-filename.jsp file 70 is replaced by one or more placeholder JavaScript functions. The static-only-filename.jsp file 70 with the one or more placeholder JavaScript functions is then compiled, deployed and run to obtain the static-JSP-HTML file 62. The dynamic data is placed in the dynamic-only-filename-XML.jsp file 48. The tool next creates the facade-JSP-filename 34 with contents as previously described.

Although the present invention is described as implemented in the above-described embodiment, it is not to be construed to be limited as such. For example, the invention may not be limited to implementation on the Internet. The invention may be implemented on an Intranet or even on a single client-server pair.

I claim:

1. A method of rendering a page on a first computer comprising:
receiving data of the page from a second computer, the data including a dynamic reference referencing dynamic data that at least partially defines the page;
partially rendering the page on the first computer by first rendering available page data other than the dynamic data;
receiving the dynamic data associated with the dynamic reference; and
rendering the received dynamic data to thereby complete rendering of the page on the first computer.

2. A method according to claim 1, further including requesting the dynamic data using the dynamic reference.

3. A method according to claim 1, wherein the dynamic reference includes a JavaScript.

4. A method according to claim 1, wherein partially rendering the page on the first computer includes partially rendering static data that defines the page on the first computer.

5. A method according to claim 4, wherein the static data is referenced by a static reference in the received page data.

6. A method according to claim 5, further including requesting the static data from the second computer using the static reference if the static data is determined not to be available on the first computer.

7. A method according to claim 6, further including storing the static data on the first computer for subsequent use after the static data has been received from the second computer.

8. A system for transferring a file containing data that defines a page for rendering comprising:
a server that holds the page data, wherein the page data includes a dynamic reference for referencing dynamic data that at least partially defines the page, the first server serving the page data and prepares the dynamic data for the client in response to the page request; and
a client that requests and receives the page data from the server, the client partially rendering the page by first rendering available page data other than the dynamic data and subsequently rendering the dynamic data when received to thereby complete rendering of the page.

9. A system according to claim 8, wherein the client requests for the dynamic data using the dynamic reference.

10. A system according to claim 9, wherein the dynamic reference includes a JavaScript.

11. A system according to claim 10, wherein the available page data other than the dynamic data includes static data.

12. A system according to claim 11, wherein the static data is referenced by a static reference in the page data received from the first server.

13. A system according to claim 12, wherein the client requests the static data from the first server using the static reference if the static data is determined not to be available on the client.

14. A program storage device readable by a computing device, tangibly embodying a program of instructions, executable by the computing device to perform the method for rendering a page on a first computer, the method comprising:
receiving data of the page from a second computer, the data including a dynamic reference referencing dynamic data that at least partially defines the page;
partially rendering the page on the first computer by first rendering available page data other than the dynamic data;
receiving the dynamic data associated with the dynamic reference; and
rendering the received dynamic data to thereby complete rendering of the page on the first computer.
